(19) United States
(12) Patent Application Publication
(10) Pub. No.: US 2019/0042305 A1
(43) Pub. Date: Feb. 7, 2019

(54) TECHNOLOGIES FOR MOVING WORKLOADS BETWEEN HARDWARE QUEUE MANAGERS

(71) Applicant: Intel Corporation, Santa Clara, CA (US)

(72) Inventors: Niall D. McDonnell, Limerick (IE); Debra Bernstein, Sudbury, MA (US); Patrick Fleming, Slatt Wolfhill (IE); Chris Macnamara, Limerick (IE); Andrew Cunningham, Ennis (IE); Bruce Richardson, Shannon (IE); Brendan N. Ryan, Limerick (IE)

(21) Appl. No.: 15/912,746

(22) Filed: Mar. 6, 2018

(51) Int. Cl. G06F 9/48; G06F 9/50

(52) U.S. Cl. CPC G06F 9/4881; G06F 9/4856; G06F 9/5088

(57) ABSTRACT

Technologies for moving workloads between hardware queue managers include a compute device. The compute device includes a set of hardware queue managers. Each hardware queue manager is to manage one or more queues of queue elements and each queue element is indicative of a data set to be operated on by a thread. The compute device also includes circuitry to execute a workload with a first hardware queue manager of the set of hardware queue managers, determine whether a workload migration condition is present, determine whether a second hardware queue manager of the set of hardware queue managers has sufficient capacity to manage a set of queues associated with the workload, move, in response to a determination that the second hardware queue manager does have sufficient capacity, the workload to the second hardware queue manager, and reduce, after the move of the workload to the second hardware queue manager, a power usage of the first hardware queue manager.

### BACKGROUND

Some compute devices include multiple cores (e.g., processing units that each read and execute instructions, such as in separate threads) which operate on data using queues and a credit scheme. The credit scheme operates as a mechanism for determining whether a queue has room for additional data to be operated on (e.g., by a thread). In the credit scheme, some threads may produce queue elements, representing sets of data (e.g., packets) to be operated on by other threads. In adding a queue element to a queue to be processed by another thread (e.g., a worker thread or a consumer thread), a producer thread subtracts a credit from a credit pool. Conversely, a thread that removes the queue element from the queue and operates on the data adds a credit back to the credit pool. The management of the queues and the credits may be performed in software or, in some compute devices, in specialized circuitry (e.g., hardware queue managers) that enables more efficient management of the queues and credits. In systems that do utilize hardware queue managers (e.g., to provide queue and credit management operations for a relatively large number of cores and workloads), inefficiencies may arise, as each hardware queue manager operates at full power (e.g., not in a low power state) regardless of whether the hardware queue manager is managing a relatively low load or a relatively high load.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a compute device for moving workloads between hardware queue managers;

FIG. 2 is a simplified block diagram of at least one embodiment of an environment that may be established by the compute device of FIG. 1;

FIGS. 3-5 are a simplified flow diagram of at least one embodiment of a method for moving a workload between hardware queue managers that may be performed by the compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

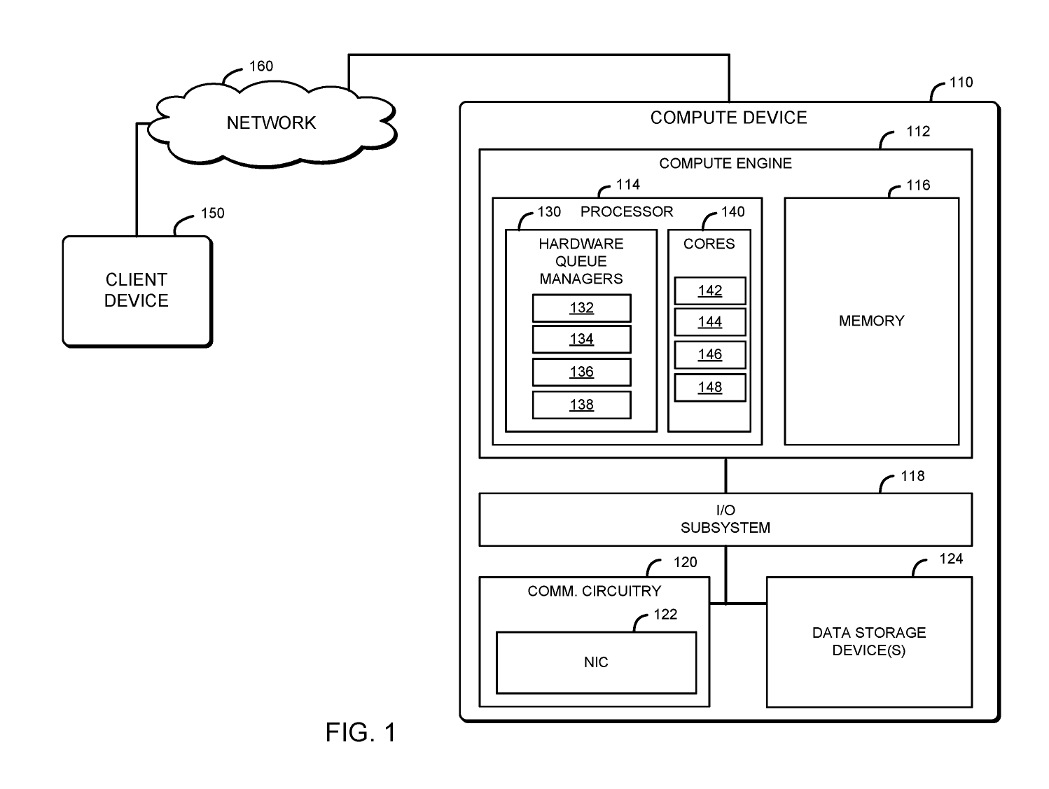

Referring now to FIG. 1, a compute device 110 for moving a workload (e.g., an application, a virtual machine, a process, etc.) between hardware queue managers (HQMs) 130 is in communication with a client device 150 through a network 160. The compute device 110, in operation, may execute multiple workloads (e.g., on behalf of the client device 150), using separate hardware queue managers 130 (e.g., one for each workload) and selectively move workloads off of one of the hardware queue managers 130 and onto another one of the hardware queue managers 130 to enable the original hardware queue manager 130 to be placed in a low power mode (e.g., deactivated). In doing so, and as explained in more detail herein, the compute device 110 continually determines whether conditions are present that would enable a workload to be moved from one hardware queue manager 130 to another hardware queue manager 130, including determining whether the present level of activity of the workload satisfies a threshold (e.g., is relatively low) and whether another hardware queue manager 130 present in the compute device 110 has sufficient capacity to manage the workload. By moving workloads off of a hardware queue manager 130, the compute device 110 may consolidate the workloads to fewer than the total amount of hardware queue managers 130 present in the compute device 110 and deactivate those that are not presently managing any workloads, thereby improving the power efficiency of the compute device 110 over typical compute devices.

The compute device 110 may be embodied as any type of device capable of performing the functions described herein, including executing a workload with one hardware queue manager 130 of a set of hardware queue managers 130, determining whether a workload migration condition is present, determining whether another hardware queue manager 130 in the set of hardware queue managers 130 has sufficient capacity to manage a set of queues associated with the workload, move, in response to a determination that the other hardware queue manager 130 does have sufficient capacity, the workload to the other hardware queue manager 130, and reduce, after moving the workload to the other hardware queue manager 130, a power usage of the hardware queue manager 130 that the workload was moved from.

As shown in FIG. 1, the illustrative compute device 110 includes a compute engine 112, an input/output (I/O) subsystem 118, communication circuitry 120, and one or more data storage devices 124. Of course, in other embodiments, the compute device 110 may include other or additional components, such as those commonly found in a computer (e.g., a display, peripheral devices, etc.). Additionally, in some embodiments, one or more of the illustrative components may be incorporated in, or otherwise form a portion of, another component. The compute engine 112 may be embodied as any type of device or collection of devices capable of performing various compute functions described below. In some embodiments, the compute engine 112 may be embodied as a single device such as an integrated circuit, an embedded system, a field-programmable gate array (FPGA), a system-on-a-chip (SOC), or other integrated system or device. In the illustrative embodiment, the compute engine 112 includes or is embodied as a processor 114 and a memory 116. The processor 114 may be embodied as any type of processor capable of performing the functions described herein. For example, the processor 114 may be embodied as a multi-core processor(s), a microcontroller, or other processor or processing/controlling circuit. In some embodiments, the processor 114 may be embodied as, include, or be coupled to an FPGA, an application specific integrated circuit (ASIC), reconfigurable hardware or hardware circuitry, or other specialized hardware to facilitate performance of the functions described herein. In the illustrative embodiment, the processor 114 includes a set of hardware queue managers 132, 134, 136, and 138 and a corresponding set of cores 142, 144, 146, and 148 (collectively, the cores 140). The hardware queue managers 130 may each be embodied as any device or circuitry capable of managing the enqueueing of queue elements from producer threads and assigning the queue elements to worker threads and consumer threads of a workload for operation on the data associated with each queue element. Each of the cores 140 may be embodied as any device or circuitry capable of receiving instructions and performing calculations or actions based on those instructions and executing the threads of a workload to produce queue elements and to operate on the queue elements (e.g., with worker and/or consumer threads). While four hardware queue managers 130 and four cores 140 are shown in the processor 114, it should be understood that in other embodiments, the number of hardware queue elements 130 and cores 140 may be different.

The main memory 116 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 116 may be integrated into the processor 114. In operation, the main memory 116 may store various software and data used during operation such as workload data, hardware queue manager data, migration condition data, applications, programs, libraries, and drivers.

The compute engine 112 is communicatively coupled to other components of the compute device 110 via the I/O subsystem 118, which may be embodied as circuitry and/or components to facilitate input/output operations with the compute engine 112 (e.g., with the processor 114 and/or the main memory 116) and other components of the compute device 110. For example, the I/O subsystem 118 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 118 may form a portion of a system-on-a-chip (SoC) and be incorporated, along with one or more of the processor 114, the main memory 116, and other components of the compute device 110, into the compute engine 112.

The communication circuitry 120 may be embodied as any communication circuit, device, or collection thereof, capable of enabling communications over the network 160 between the compute device 110 and another compute device (e.g., the client device 150, etc.). The communication circuitry 120 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 120 includes a network interface controller (NIC) 122, which may also be referred to as a host fabric interface (HFI). The NIC 122 may be embodied as one or more add-in-boards, daughter cards, network interface cards, controller chips, chipsets, or other devices that may be used by the compute device 110 to connect with another compute device (e.g., the client device 150, etc.). In some embodiments, the NIC 122 may be embodied as part of a system-on-a-chip (SoC) that includes one or more processors, or included on a multichip package that also contains one or more processors. In some embodiments, the NIC 122 may include a local processor (not shown) and/or a local memory (not shown) that are both local to the NIC 122. In such embodiments, the local processor of the NIC 122 may be capable of performing one or more of the functions of the compute engine 112 described herein. Additionally or alternatively, in such embodiments, the local memory of the NIC 122 may be integrated into one or more components of the compute device 110 at the board level, socket level, chip level, and/or other levels.

The one or more illustrative data storage devices 124 may be embodied as any type of devices configured for short-term or long-term storage of data such as, for example, memory devices and circuits, memory cards, hard disk drives, solid-state drives, or other data storage devices. Each data storage device 124 may include a system partition that stores data and firmware code for the data storage device 124. Each data storage device 124 may also include one or more operating system partitions that store data files and executables for operating systems.

The client device 150 may have components similar to those described in FIG. 1 with reference to the compute device 110. The description of those components of the compute device 110 is equally applicable to the description of components of the client device and is not repeated herein for clarity of the description. Further, it should be appreciated that any of the compute device 110 and the client device 150 may include other components, sub-components, and devices commonly found in a computing device, which are not discussed above in reference to the compute device 110 and not discussed herein for clarity of the description.

As described above, the compute device 110 and the client device 150 are illustratively in communication via the network 160, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

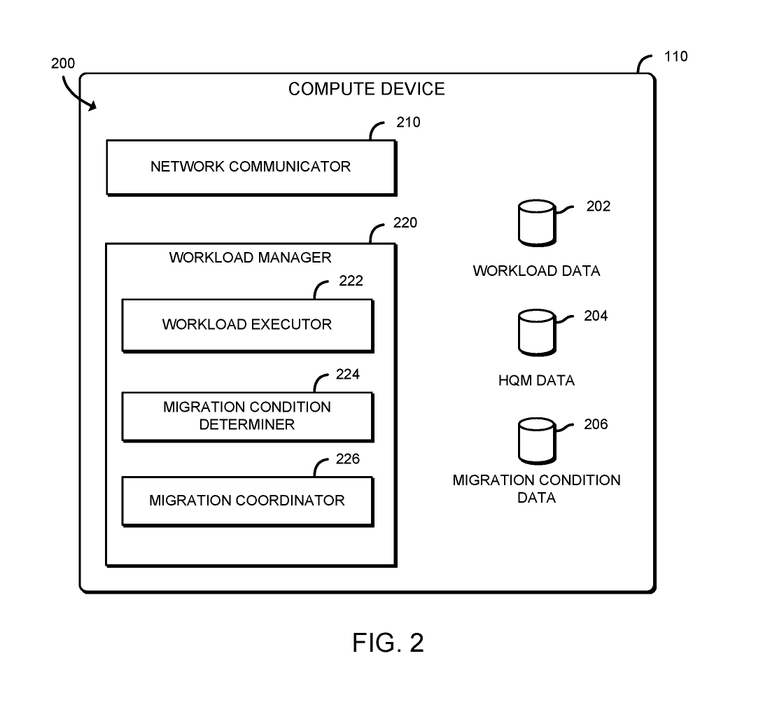

Referring now to FIG. 2, the compute device 110 may establish an environment 200 during operation. The illustrative environment 200 includes a network communicator 210 and a workload manager 220. Each of the components of the environment 200 may be embodied as hardware, firmware, software, or a combination thereof. As such, in some embodiments, one or more of the components of the environment 200 may be embodied as circuitry or a collection of electrical devices (e.g., network communicator circuitry 210, workload manager circuitry 220, etc.). It should be appreciated that, in such embodiments, one or more of the network communicator circuitry 210 or workload manager circuitry 220 may form a portion of one or more of the compute engine 112, the processor 114, the memory 116, the communication circuitry 120, the I/O subsystem 118 and/or other components of the compute device 110. In the illustrative embodiment, the environment 200 includes workload data 202, which may be embodied as any data indicative of workloads and the threads associated with each workload, input data to be operated on by each workload (e.g., data received from the client device 150) and output data produced by each workload (e.g., data to be sent to the client device 150). The illustrative environment 200 also includes hardware queue manager data 204, which may be embodied as any data indicative of identifiers of the hardware queue managers 130, the present resources available on each hardware queue manager 130 (e.g., ports, queue identifiers, etc.), assignments of workloads to the hardware queue managers 130, memory addresses used by each hardware queue manager 130, the status (e.g., number of queue entities in each queue) of each queue managed by each hardware queue manager 130, and the number of credits in a credit pool (e.g., a global variable shared by the threads of a given workload) for each workload associated with the corresponding hardware queue manager 130. Additionally, the illustrative environment 200 includes migration condition data 206, which may be embodied as any data indicative of conditions under which a workload should be migrated from one hardware queue manager 130 to another hardware queue manager 130 (e.g., a predefined level of activity such as a number of queue elements processed by the threads of the workload over a predefined time period, a time period typically associated with a relatively low level of activity or a relatively high level of activity, etc.) to either consolidate workloads onto a fewer number of hardware queue managers 130 (e.g., during periods of low activity) and deactivate the other hardware queue managers 130, or to distribute the workloads across more of the hardware queue managers 130 (e.g., during periods of higher activity).

In the illustrative environment 200, the network communicator 210, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the compute device 110, respectively. To do so, the network communicator 210 is configured to receive and process data packets from one system or computing device (e.g., the client device 150, etc.) and to prepare and send data packets to a computing device or system (e.g., the client device 150, etc.). Accordingly, in some embodiments, at least a portion of the functionality of the network communicator 210 may be performed by the communication circuitry 120, and, in the illustrative embodiment, by the NIC 122.

The workload manager 220, which may be embodied as hardware, firmware, software, virtualized hardware, emulated architecture, and/or a combination thereof, is configured to execute workloads and selectively consolidate workloads onto a relatively lower number of hardware queue managers 130 (e.g., during periods of low activity) and deactivate unused hardware queue managers 130, or distribute the workloads across relatively more hardware queue managers 130 (e.g., during periods of higher activity). To do so, in the illustrative embodiment, the workload manager 220 includes a workload executor 222, a migration condition determiner 224, and a migration coordinator 226. The workload executor 222, in the illustrative embodiment, is configured to execute workloads using the cores 140 of the processor 114. In doing so, the workload executor 222 may receive packets from the communication circuitry 120 using a dedicated core 142 (e.g., an Rx core) to produce queue element(s) representative of the data in the received packets. Further the workload executor 222 may operate on the data in the packets associated with the queue element(s) using worker threads corresponding to other cores, such as the cores 144, 146, and may send outgoing packets resulting from the operations of the worker threads using another core, such as the core 148 (e.g., a Tx core).

The migration condition determiner 224, in the illustrative embodiment, is configured to continually determine whether a condition has occurred under which one or more workloads should moved between hardware queue managers 130, either to consolidate the workloads onto fewer hardware queue managers 130 or to distribute the workloads across more hardware queue managers 130. In the illustrative embodiment, the migration condition determiner 224 may compare a present level of activity associated with each workload (e.g., a number of packets being processed by the threads of the workload during a predefined period of time, such as a second or a minute) and determine whether the level of activity is low enough to satisfy a predefined threshold indicative of a low level of activity under which the workload should be moved to another hardware queue manager 130 to enable the source hardware queue manager 130 (e.g., the hardware queue manager 130 from which the workload is moved) to be deactivated. Conversely, the migration condition determiner 224 may determine whether the level of activity satisfies a higher predefined threshold, in which case the workload should be moved to a less heavily loaded hardware queue manager 130. In some embodiments, the migration condition determiner 224 may be configured determine whether the present time is within a time period known to be associated with a low level of activity for a workload, and if so, determine that the workload should be consolidated with other workloads onto another hardware queue manager 130 or conversely that the workload should be moved to a less heavily loaded hardware queue manager 130 to accommodate an expected higher level of activity. The migration coordinator 226, in the illustrative embodiment, is configured to determine which hardware queue manager 130 has sufficient capacity (e.g., a threshold number of ports, queue identifiers, etc.) to manage the queues for a workload to be moved. The migration coordinator is further to provide signals to the threads of the workload that the workload is to be moved to another hardware queue manager 130 and move the workload to the hardware queue manager 130 that has been determined to have sufficient capacity, including remapping memory addresses used by the workload, to enable the threads of the workload to communicate with the target hardware queue manager 130 (e.g., the hardware queue manager 130 to which the workload will be moved) rather than the source hardware queue manager 130 (e.g., the hardware queue manager 130 from which the workload will be moved).

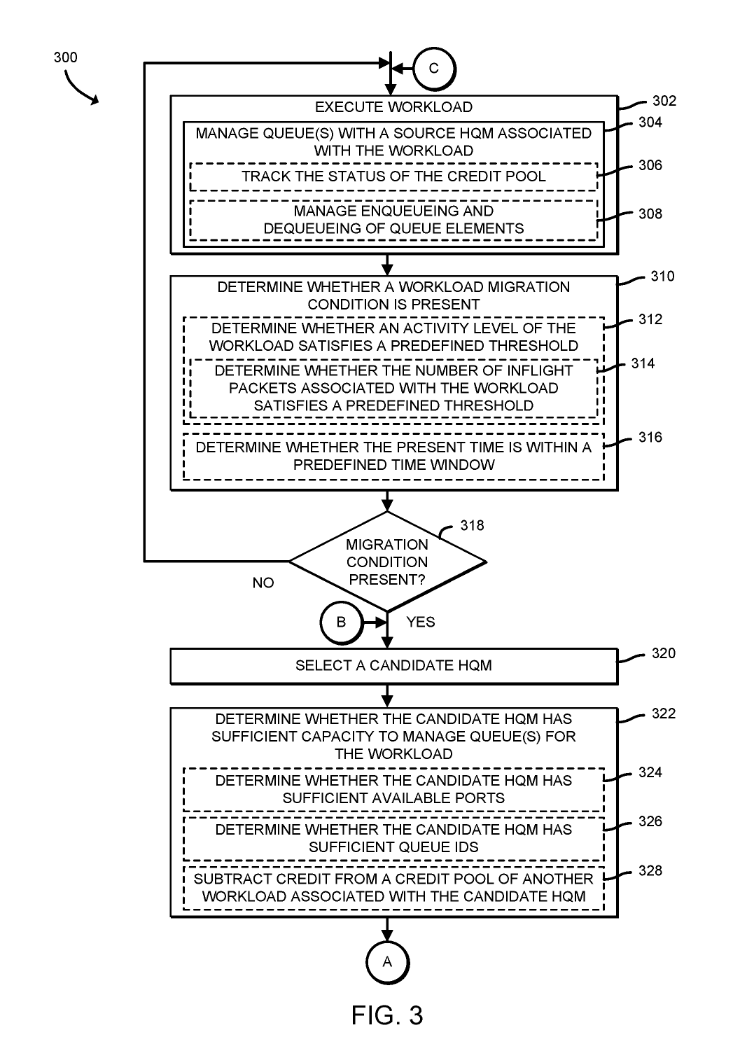

Referring now to FIG. 3, the compute device 110, in operation, may execute a method 300 for moving a workload between hardware queue managers 130. The method 300 begins with block 302, in which the compute device 110 executes a workload. In doing so, and as indicated in block 304, the compute device 110 manages queues of the workload with a source hardware queue manager 130 associated with the workload (e.g., the hardware queue manager 130 to which the workload is presently assigned). In managing the queues, the compute device 110, in the illustrative embodiment, tracks the status of the credit pool associated with the workload, as indicated in block 306. Further, in the illustrative embodiment, the compute device 110 manages the enqueueing of queue elements (e.g., by one or more producer threads of the workload) and the dequeueing of queue elements (e.g., by worker threads and other consumer threads of the workload), as indicated in block 308. As indicated in block 310, the compute device 110 also determines whether a workload migration condition is present. In doing so, the compute device 110 may determine whether an activity level of the workload satisfies a predefined threshold, as indicated in block 312. As described above, the activity level may be embodied as the number of packets processed by the threads of the workload over a predefined period of time, or another measure of throughput of the workload. As indicated in block 314, the compute device 110 may determine whether the number of inflight packets (e.g., queue elements that have not been completely processed by the consumer thread(s)) satisfies a predefined threshold. In some embodiments, if the number of inflight packets is equal to or greater than a predefined number, the compute device 110 may determine that the risk of dropping the packets during a migration is too great and that a migration condition is not present. Additionally or alternatively, as indicated in block 316, the compute device 110 may determine whether the present time is within a predefined time window (e.g., a time window associated with a particular level of activity that warrants moving the workload to another hardware queue manager 130).

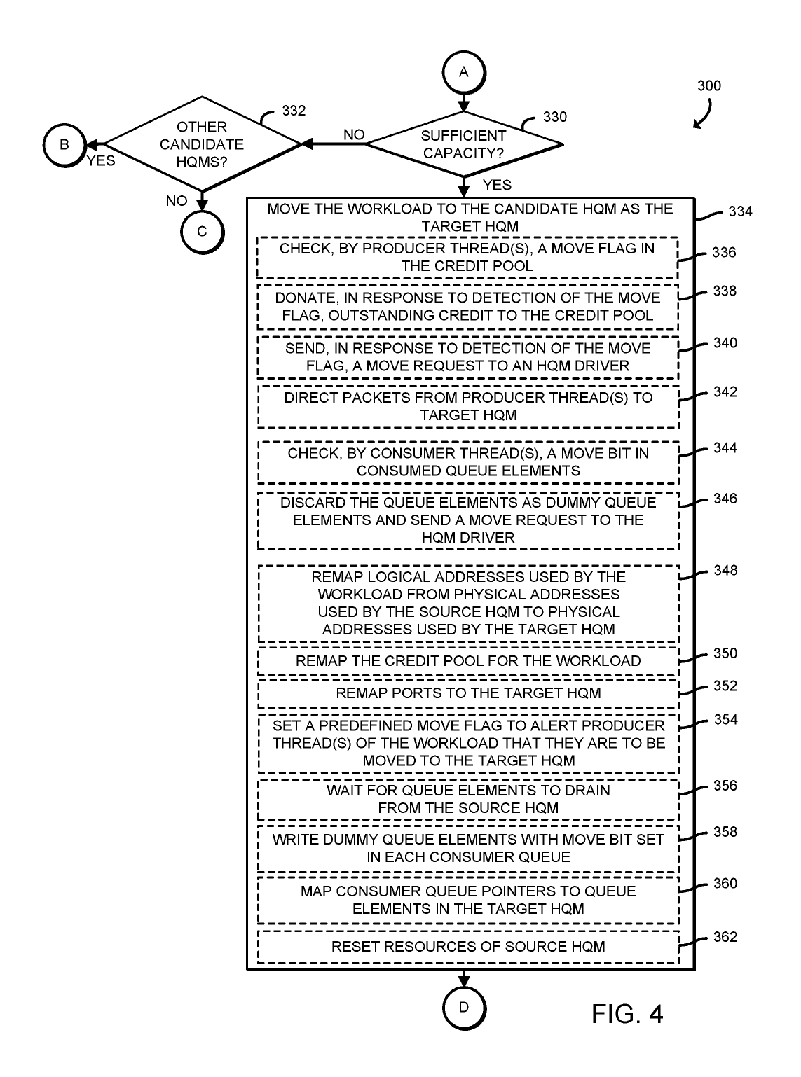

In block 318, the compute device 110 determines the subsequent course of action as a function of whether a migration condition was determined to be present in block 310. If a migration condition is not present, the method 300 loops back to block 302, in which the compute device 110 continues execution of the workload. Otherwise, if a migration condition is present, the method 300 advances to block 320 in which the compute device 110 selects a hardware queue manager 130 from the set of hardware queue managers 130 as a candidate for receiving the workload. In block 322, the compute device 110 determines whether the candidate hardware queue manager 130 has sufficient capacity to manage the queues of the workload. In doing so, the compute device 110 determines whether the candidate hardware queue manager 130 has sufficient available ports for the workload (e.g., the number of the ports that the thread(s) of the workload presently utilize on the source hardware queue manager 130), as indicated in block 324. Additionally or alternatively, the compute device 110 may determine whether the candidate hardware queue manager 130 has sufficient queue ids (e.g., available indexes to assign to queues utilized by the threads of the workload), as indicated in block 326. Additionally, and as indicated in block 328, the compute device 110 may subtract credit (e.g., in an atomic operation) from another workload utilizing the candidate hardware queue manager 130 to provide additional capacity for the workload that is to be moved. Subsequently, the method 300 advances to block 330 of FIG. 4, in which the compute device 110 determines whether the candidate hardware queue manager 130 has sufficient capacity to manage the queues of the workload.

Referring now to FIG. 4, if the compute device 110 has determined that the candidate hardware queue manager 130 does not have sufficient capacity, the method 300 advances to block 332, in which the compute device 110 determines whether other hardware queue managers 130 are present in the compute device 110 that have not been tested for their capacity. If so, the method 300 loops back to block 320 of FIG. 3, in which the compute device 110 selects one of the other hardware queue managers 130 and determines whether that hardware queue manager 130 has sufficient capacity for the workload. Otherwise, the method 300 loops back to block 302, in which the compute device 110 continues execution of the workload. Referring back to block 330, if the compute device 110 instead determines that the candidate hardware queue manager 130 does have sufficient capacity, the method 300 advances to block 334, in which the compute device 110 moves the workload to the candidate hardware queue manager 130, which is referred to in the subsequent blocks as the target hardware queue manager 130.

In moving the workload to the target hardware queue manager 130, the compute device 110 may check, with one or more producer threads (e.g., with one or more of the cores assigned to provide packets to a hardware queue manager 130 for insertion into a queue as queue element(s)) whether a move flag (e.g., a designated bit) in the credit pool (e.g., a global variable indicative of the number of credits available for use by threads of the workload) has been set (e.g., to one), as indicated in block 336. In response to detecting that the move flag has been set, the compute device 110 may donate any outstanding credits to the credit pool, as indicated in block 338. Further, the producer thread(s) of the workload may send, in response to a detection that the move flag has been set, a move request to a driver for the hardware queue managers 130 (e.g., through an application programming interface (API) call), as indicated in block 340. Further, the producer thread(s) may direct incoming packets (e.g. from the communication circuitry 120) to the target hardware queue manger 130, as indicated in block 342. In some embodiments, the API call to the driver causes the redirection of incoming packets to the target hardware queue manager 130 (e.g., the driver may remap the page tables of the workload such that the target hardware queue manager 130 is mapped to the memory location that the source hardware queue manager 130 was previously mapped to).

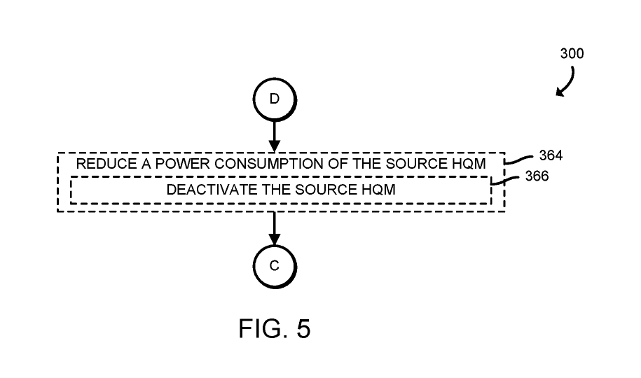

As indicated in block 344, the compute device 110 may check, with one or more consumer threads (e.g., threads that dequeue queue elements and operate on the underlying data), whether a move bit has been set in any of the queue elements. Further, in response to detection that the move bit has been set, the consumer thread(s) may discard the queue element(s) as dummy (e.g., fake) queue element(s) and send a move request to a driver for the hardware queue managers 130 (e.g., through an API call), as indicated in block 346. While blocks 336 through 342 are performed by producer thread(s) and blocks 344 through 346 are performed by consumer thread(s), in the illustrative embodiment, blocks 348 through 362 are performed by a kernel executed by the compute device 110 to complete the move. In block 348, the compute device 110 remaps logical addresses used by the workload from physical addresses used by the source hardware queue manager 130 to physical addresses used by the target hardware queue manager 130. As indicated in block 350, the compute device 110 may remap the credit pool (e.g., a global variable) for the workload. Further, as indicated in block the compute device 110 may remap ports used by the workload to those of the target hardware queue manager 130 (e.g., map logical memory addresses used by the thread(s) of the workload to physical memory addresses for ports of the target hardware queue manager 130, rather than to physical memory addresses for ports of the source hardware queue manager 130). As indicated in block 354, the compute device 110 may set, with the kernel, a predefined move flag to alert producer thread(s) of the workload that they are to be moved to the target hardware queue manager 130 (e.g., the flag referenced in block 336 above). As indicated in block 356, the compute device 110 may wait for queue elements to drain from the source hardware queue manager 130 (e.g., be processed by the worker and consumer threads of the workload and removed from the queues). The compute device 110 may continually poll the internal state of the hardware queue manager 130 to determine when the queue elements have completely drained from the source hardware queue manager 130. As indicated in block 358, after the queue elements have drained from the source hardware queue manager 130, the compute device 110 may write dummy queue element(s) with a move bit set into the queues of the consumer threads (e.g., the queue elements referenced in blocks 344 and 346). Additionally, the compute device 110, in the illustrative embodiment, maps consumer queue pointers to correspond queue elements in the target hardware queue manager (e.g., queue elements resulting from the producer thread(s) redirecting incoming packets to the target hardware queue manager 130 in block 342), as indicated in block 360. Further, the compute device 110, through the kernel, may reset resources of the source hardware queue manager (e.g., wiping any variables or other data maintained by the source hardware queue manager), as indicated in block 362. Subsequently, the method 300 advances to block 364 of FIG. 5, in which the compute device 110 may reduce a power consumption of the source hardware queue manager (e.g., if the source hardware queue manager is no longer assigned to any workloads). In doing so, in the illustrative embodiment, the compute device 110 deactivates (e.g., fully power gates) the source hardware queue manager 130, as indicated in block 366. Subsequently, the method 300 loops back to block 302, in which the compute device 110 continues execution of the workload.

### EXAMPLES

Illustrative examples of the technologies disclosed herein are provided below. An embodiment of the technologies may include any one or more, and any combination of, the examples described below.

Example 1 includes a compute device comprising a plurality of hardware queue managers, wherein each hardware queue manager is to manage one or more queues of queue elements and wherein each queue element is indicative of a data set to be operated on by a thread; and circuitry to (i) execute a workload with a first hardware queue manager of the plurality of hardware queue managers, (ii) determine whether a workload migration condition is present, (iii) determine whether a second hardware queue manager of the plurality of hardware queue managers has sufficient capacity to manage a set of queues associated with the workload, (iv) move, in response to a determination that the second hardware queue manager does have sufficient capacity, the workload to the second hardware queue manager, and (v) reduce, after the move of the workload to the second hardware queue manager, a power usage of the first hardware queue manager.

Example 2 includes the subject matter of Example 1, and wherein to reduce the power usage of the first hardware queue manager comprises to deactivate the first hardware queue manager.

Example 3 includes the subject matter of any of Examples 1 and 2, and wherein to determine whether a workload migration condition is present comprises to determine whether an activity level of the workload satisfies a predefined threshold.

Example 4 includes the subject matter of any of Examples 1-3, and wherein to determine whether a workload migration condition is present comprises to determine whether the present time is within a predefined time window.

Example 5 includes the subject matter of any of Examples 1-4, and wherein to determine whether a workload migration condition is present comprises to determine whether a number of inflight packs associated with the workload satisfies a predefined threshold.

Example 6 includes the subject matter of any of Examples 1-5, and wherein to determine whether the second hardware queue manager has sufficient capacity comprises to determine whether the second hardware queue manager has a predefined number of available ports.

Example 7 includes the subject matter of any of Examples 1-6, and wherein the circuitry is further to subtract, prior to moving the workload to the second hardware queue manager, one or more credits from a credit pool associated with a second workload managed by the second hardware queue manager.

Example 8 includes the subject matter of any of Examples 1-7, and wherein to move the workload to the second hardware queue manager comprises to remap a logical address used by the workload from a first physical address used by the first hardware queue manager to a second physical address used by the second hardware queue manager.

Example 9 includes the subject matter of any of Examples 1-8, and wherein to move the workload to the second hardware queue manager comprises to direct packets from one or more producer threads of the workload to the second hardware queue manager.

Example 10 includes the subject matter of any of Examples 1-9, and wherein to move the workload to the second hardware queue manager comprises to set a predefined move flag in a credit pool used by one or more producer threads of the workload.

Example 11 includes the subject matter of any of Examples 1-10, and wherein to move the workload to the second hardware queue manager comprises to set a move bit in a queue element and enqueue the queue element into a queue used by a consumer thread of the workload.

Example 12 includes the subject matter of any of Examples 1-11, and wherein to move the workload to the second hardware queue manager comprises to send, in response to detection of a move flag in a credit pool or in a queue element, a move request from a thread of the workload to a hardware queue manager driver.

Example 13 includes the subject matter of any of Examples 1-12, and further including a plurality of processor cores, wherein each core corresponds to a thread of the workload.

Example 14 includes one or more machine-readable storage media comprising a plurality of instructions stored thereon that, in response to being executed, cause a compute device to execute a workload with a first hardware queue manager of a plurality of hardware queue managers, wherein each hardware queue manager is to manage one or more queues of queue elements and wherein each queue element is indicative of a data set to be operated on by a thread; determine whether a workload migration condition is present; determine whether a second hardware queue manager of the plurality of hardware queue managers has sufficient capacity to manage a set of queues associated with the workload; move, in response to a determination that the second hardware queue manager does have sufficient capacity, the workload to the second hardware queue manager; and reduce, after the move of the workload to the second hardware queue manager, a power usage of the first hardware queue manager.

Example 15 includes the subject matter of Example 14, and wherein to reduce the power usage of the first hardware queue manager comprises to deactivate the first hardware queue manager.

Example 16 includes the subject matter of any of Examples 14 and 15, and wherein to determine whether a workload migration condition is present comprises to determine whether an activity level of the workload satisfies a predefined threshold.

Example 17 includes the subject matter of any of Examples 14-16, and wherein to determine whether a workload migration condition is present comprises to determine whether the present time is within a predefined time window.

Example 18 includes the subject matter of any of Examples 14-17, and wherein to determine whether a workload migration condition is present comprises to determine whether a number of inflight packs associated with the workload satisfies a predefined threshold.

Example 19 includes the subject matter of any of Examples 14-18, and wherein to determine whether the second hardware queue manager has sufficient capacity comprises to determine whether the second hardware queue manager has a predefined number of available ports.

Example 20 includes the subject matter of any of Examples 14-19, and wherein the circuitry is further to subtract, prior to moving the workload to the second hardware queue manager, one or more credits from a credit pool associated with a second workload managed by the second hardware queue manager.

Example 21 includes the subject matter of any of Examples 14-20, and wherein to move the workload to the second hardware queue manager comprises to remap a logical address used by the workload from a first physical address used by the first hardware queue manager to a second physical address used by the second hardware queue manager.

Example 22 includes the subject matter of any of Examples 14-21, and wherein to move the workload to the second hardware queue manager comprises to direct packets from one or more producer threads of the workload to the second hardware queue manager.

Example 23 includes the subject matter of any of Examples 14-22, and wherein to move the workload to the second hardware queue manager comprises to set a predefined move flag in a credit pool used by one or more producer threads of the workload.

Example 24 includes the subject matter of any of Examples 14-23, and wherein to move the workload to the second hardware queue manager comprises to set a move bit in a queue element and enqueue the queue element into a queue used by a consumer thread of the workload.

Example 25 includes a compute device comprising circuitry for executing a workload with a first hardware queue manager of a plurality of hardware queue managers, wherein each hardware queue manager is to manage one or more queues of queue elements and wherein each queue element is indicative of a data set to be operated on by a thread; means for determining whether a workload migration condition is present; means for determining whether a second hardware queue manager of the plurality of hardware queue managers has sufficient capacity to manage a set of queues associated with the workload; means for moving, in response to a determination that the second hardware queue manager does have sufficient capacity, the workload to the second hardware queue manager; and circuitry for reducing, after the move of the workload to the second hardware queue manager, a power usage of the first hardware queue manager.

Example 26 includes a method comprising executing, by a compute device, a workload with a first hardware queue manager of a plurality of hardware queue managers, wherein each hardware queue manager is to manage one or more queues of queue elements and wherein each queue element is indicative of a data set to be operated on by a thread; determining, by the compute device, whether a workload migration condition is present; determining, by the compute device, whether a second hardware queue manager of the plurality of hardware queue managers has sufficient capacity to manage a set of queues associated with the workload; moving, by the compute device and in response to a determination that the second hardware queue manager does have sufficient capacity, the workload to the second hardware queue manager; and reducing, by the compute device and after the move of the workload to the second hardware queue manager, a power usage of the first hardware queue manager.

Example 27 includes the subject matter of Example 26, and wherein reducing the power usage of the first hardware queue manager comprises deactivating the first hardware queue manager.

Example 28 includes the subject matter of any of Examples 26 and 27, and wherein determining whether a workload migration condition is present comprises determining whether an activity level of the workload satisfies a predefined threshold.

1. A compute device comprising:
a plurality of hardware queue managers, wherein each hardware queue manager is to manage one or more queues of queue elements and wherein each queue element is indicative of a data set to be operated on by a thread; and
circuitry to: (i) execute a workload with a first hardware queue manager of the plurality of hardware queue managers, (ii) determine whether a workload migration condition is present, (iii) determine whether a second hardware queue manager of the plurality of hardware queue managers has sufficient capacity to manage a set of queues associated with the workload, (iv) move, in response to a determination that the second hardware queue manager does have sufficient capacity, the workload to the second hardware queue manager, and (v) reduce, after the move of the workload to the second hardware queue manager, a power usage of the first hardware queue manager.

2. The compute device of claim 1, wherein to reduce the power usage of the first hardware queue manager comprises to deactivate the first hardware queue manager.

3. The compute device of claim 1, wherein to determine whether a workload migration condition is present comprises to determine whether an activity level of the workload satisfies a predefined threshold.

4. The compute device of claim 1, wherein to determine whether a workload migration condition is present comprises to determine whether the present time is within a predefined time window.

5. The compute device of claim 1, wherein to determine whether a workload migration condition is present comprises to determine whether a number of inflight packs associated with the workload satisfies a predefined threshold.

6. The compute device of claim 1, wherein to determine whether the second hardware queue manager has sufficient capacity comprises to determine whether the second hardware queue manager has a predefined number of available ports.

7. The compute device of claim 1, wherein the circuitry is further to subtract, prior to moving the workload to the second hardware queue manager, one or more credits from a credit pool associated with a second workload managed by the second hardware queue manager.

8. The compute device of claim 1, wherein to move the workload to the second hardware queue manager comprises to remap a logical address used by the workload from a first physical address used by the first hardware queue manager to a second physical address used by the second hardware queue manager.

9. The compute device of claim 1, wherein to move the workload to the second hardware queue manager comprises to direct packets from one or more producer threads of the workload to the second hardware queue manager.

10. The compute device of claim 1, wherein to move the workload to the second hardware queue manager comprises to set a predefined move flag in a credit pool used by one or more producer threads of the workload.

11. The compute device of claim 1, wherein to move the workload to the second hardware queue manager comprises to set a move bit in a queue element and enqueue the queue element into a queue used by a consumer thread of the workload.

12. The compute device of claim 1, wherein to move the workload to the second hardware queue manager comprises to send, in response to detection of a move flag in a credit pool or in a queue element, a move request from a thread of the workload to a hardware queue manager driver.

13. The compute device of claim 1, further comprising a plurality of processor cores, wherein each core corresponds to a thread of the workload.

14. One or more machine-readable storage media comprising a plurality of instructions stored thereon that, in response to being executed, cause a compute device to:
execute a workload with a first hardware queue manager of a plurality of hardware queue managers, wherein each hardware queue manager is to manage one or more queues of queue elements and wherein each queue element is indicative of a data set to be operated on by a thread;
determine whether a workload migration condition is present;
determine whether a second hardware queue manager of the plurality of hardware queue managers has sufficient capacity to manage a set of queues associated with the workload;
move, in response to a determination that the second hardware queue manager does have sufficient capacity, the workload to the second hardware queue manager; and
reduce, after the move of the workload to the second hardware queue manager, a power usage of the first hardware queue manager.

15. The one or more machine-readable storage media of claim 14, wherein to reduce the power usage of the first hardware queue manager comprises to deactivate the first hardware queue manager.

16. The one or more machine-readable storage media of claim 14, wherein to determine whether a workload migration condition is present comprises to determine whether an activity level of the workload satisfies a predefined threshold.

17. The one or more machine-readable storage media of claim 14, wherein to determine whether a workload migration condition is present comprises to determine whether the present time is within a predefined time window.

18. The one or more machine-readable storage media of claim 14, wherein to determine whether a workload migration condition is present comprises to determine whether a number of inflight packs associated with the workload satisfies a predefined threshold.

19. The one or more machine-readable storage media of claim 14, wherein to determine whether the second hardware queue manager has sufficient capacity comprises to determine whether the second hardware queue manager has a predefined number of available ports.

20. The one or more machine-readable storage media of claim 14, wherein the circuitry is further to subtract, prior to moving the workload to the second hardware queue manager, one or more credits from a credit pool associated with a second workload managed by the second hardware queue manager.

21. The one or more machine-readable storage media of claim 14, wherein to move the workload to the second hardware queue manager comprises to remap a logical address used by the workload from a first physical address used by the first hardware queue manager to a second physical address used by the second hardware queue manager.

22. The one or more machine-readable storage media of claim 14, wherein to move the workload to the second hardware queue manager comprises to direct packets from one or more producer threads of the workload to the second hardware queue manager.

23. The one or more machine-readable storage media of claim 14, wherein to move the workload to the second hardware queue manager comprises to set a predefined move flag in a credit pool used by one or more producer threads of the workload.

24. The one or more machine-readable storage media of claim 14, wherein to move the workload to the second hardware queue manager comprises to set a move bit in a queue element and enqueue the queue element into a queue used by a consumer thread of the workload.

25. A compute device comprising:
circuitry for executing a workload with a first hardware queue manager of a plurality of hardware queue managers, wherein each hardware queue manager is to manage one or more queues of queue elements and wherein each queue element is indicative of a data set to be operated on by a thread;
means for determining whether a workload migration condition is present;
means for determining whether a second hardware queue manager of the plurality of hardware queue managers has sufficient capacity to manage a set of queues associated with the workload;
means for moving, in response to a determination that the second hardware queue manager does have sufficient capacity, the workload to the second hardware queue manager; and
circuitry for reducing, after the move of the workload to the second hardware queue manager, a power usage of the first hardware queue manager.

26. A method comprising:
executing, by a compute device, a workload with a first hardware queue manager of a plurality of hardware queue managers, wherein each hardware queue manager is to manage one or more queues of queue elements and wherein each queue element is indicative of a data set to be operated on by a thread;
determining, by the compute device, whether a workload migration condition is present;
determining, by the compute device, whether a second hardware queue manager of the plurality of hardware queue managers has sufficient capacity to manage a set of queues associated with the workload;
moving, by the compute device and in response to a determination that the second hardware queue manager does have sufficient capacity, the workload to the second hardware queue manager; and
reducing, by the compute device and after the move of the workload to the second hardware queue manager, a power usage of the first hardware queue manager.

27. The method of claim 26, wherein reducing the power usage of the first hardware queue manager comprises deactivating the first hardware queue manager.

28. The method of claim 26, wherein determining whether a workload migration condition is present comprises determining whether an activity level of the workload satisfies a predefined threshold.
